(19) United States
(12) Patent Application Publication
(10) Pub. No.: US 2008/0033705 A1
(43) Pub. Date: Feb. 7, 2008

(54) Kinetic measurements of binding interaction with curvature evaluation

(76) Inventors: Magdalena Bynum, San Jose, CA (US); William Henry Wilson, Newark, DE (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/500,190

(22) Filed: Aug. 7, 2006

(51) Int. Cl. G06G 7/48; G06G 7/58

(52) U.S. Cl. 703/11; 703/12

(57) ABSTRACT

Data from kinetic surface plasmon resonance measurements are fitted to time-profile curves. Time profile curves with sub-threshold curvature are flagged as being insufficient to provide reliable determinations of kinetic parameters and binding affinity. The remaining curves are used to calculate the kinetic parameters and binding affinity, obviating the need for multiple runs for these purposes. The resulting increase in throughput enables drug discovery methods in which kinetic measurements are performed earlier in the screening processes, e.g., so that all or most primary-screen hits can be subjected to data-rich kinetic measurements for screening purposes.

### BACKGROUND

The present invention provides a kinetic biosensor with relatively high throughput suitable for drug discovery and other bio-analytical activities. Hereinbelow, related art is discussed to aid in understanding the invention. Related art labeled “prior art” is admitted prior art; related art not labeled “prior art” is not admitted prior art.

Many of the “miracles of modern medicine” are drugs that have been brought to market as a result of labor and time intensive process of drug discovery. Target-based drug discovery involves finding and/or designing a compound that can beneficially impact a “target” (e.g., G-protein coupled receptors, enzymes, DNA, RNA, and ribosomal targets) involved in the etiology of a disease. To these ends, various measurements are used to detect and characterize interactions between drug candidates and a target.

Label-based measurements, e.g., using fluorescently labeled analytes or competitors, have proven amenable to high levels of automation and parallelism. Accordingly, they are particularly useful for screening large numbers (e.g., ˜10⁶) of drug candidates for the relatively few (e.g., ˜10³) “hits” that interact significantly with a target. In addition, label-based measurements can be used to assess the binding strengths, dose-response relationships, and selectivity of drug candidates that do interact with the target; thus permitting selection of a reduced number (e.g., ˜10²) of leads from the hits. However, label-based measurements are not well-suited for evaluating kinetic parameters since unbound labeled material must be removed before a valid measurement can be taken. Thus, an alternative measurement approach is typically used for evaluating kinetic parameters such as rates of association (“on-rates”, which indicate how fast a drug might act) and rates of dissociation (“off-rates”, which indicate how long a drug might be effective).

Surface plasmon resonance (SPR) sensors and lesser-known optical biosensors (e.g., those using waveguides and resonant mirrors) exploit an evanescent wave phenomenon to measure changes in the index of refraction near a surface as analyte molecules bind to target receptors bound to the surface. Labeling is not required, so that unbound labeled molecules do not have to be removed before measurements can be made; thus, continuous, real-time measurements are possible. By monitoring the changes in index of refraction in real-time, on-rates and off-rates can be determined, while affinity (i.e., binding strength) can be calculated from the on-rates and off-rates. Ideally, on-rates, off-rates, and affinity are determinable from a single measurement run; in practice, however, several runs at different concentrations are required to obtain reliable values for these parameters.

SPR sensors are versatile enough to be used at all stages of target-based drug discovery, e.g., target identification and validation, screen development and screening, lead optimization, preclinical and clinical development, regulatory approval, and manufacture. However, the relatively low throughput imposes a burden on the drug discovery process that is far too time-consuming considering the challenges posed by existing diseases, let alone naturally (e.g., a new strain of bird flu) and synthetically (e.g., biological weapons) created new diseases. What is needed is an approach to measurement that provides the rich data output of kinetic measurements but with higher throughput.

### BRIEF DESCRIPTION OF THE DRAWINGS

FIG. 1 is a schematic diagram of a surface plasmon resonance sensor system in accordance with the present invention; also included is a flow chart of a sensing method in accordance with the invention and a graph of sensor response as a function of time.

FIG. 2 is a flow chart of a drug discovery method in accordance with the present invention.

### DETAILED DESCRIPTION

An SPR sensor system AP1 in accordance with the present invention provides for determining when a single run suffices for determining kinetic parameters such as association rate (kₐ) and dissociation rate (k_{d}), as well as parameters calculable from kinetic measurements, e.g., affinity (K_{D}). When a positive determination is made, the method increases analytical throughput by requiring only one run per binding pair as opposed to the more typical five. In the context of drug discovery, even when the determination is negative, throughput need not be adversely affected, as the negative determination typically indicates a poor drug candidate. Other embodiments of the invention provide other advantages instead of or in addition to higher throughput.

SPR sensor system AP1 comprises a flow channel 11, a laser 13, a prism 15, a substrate 17, a photodetector 19, a computer 21, and a display 23. Substrate 17 is glass (or other dielectric) with a coating 25, including gold (or other noble metal). SPR sensor system AP1 is designed to track binding and dissociation between a fixed interactant 31 and a mobile (while unbound) interactant 33, for example, between a fixed target and a mobile drug candidate “analyte”. The fixed interactant is immobilized on coating 25 in that it is attached to the gold or to an intermediate layer on the gold. The mobile interactant is in solution and flowed over coating 25. When bound, the fixed and mobile interactants form bound pairs 35.

In SPR sensor system AP1, most of the light incident substrate 17 is reflected. However, over a range of angles of incidence, some of the incident light is converted to an evanescent wave in the vicinity of the gold coating, resulting in a reduction in the intensity of the reflected light. The angle at which this reduction is maximal is called the “resonance” angle. The resonance angle is sensitive to the refractive index of material near the gold coating 25 opposite substrate 17. The refractive index changes with the population of bound pairs 35. Accordingly, the binding activity, as represented in the population of bound pairs can be tracked by monitoring the shift in resonance angle over time.

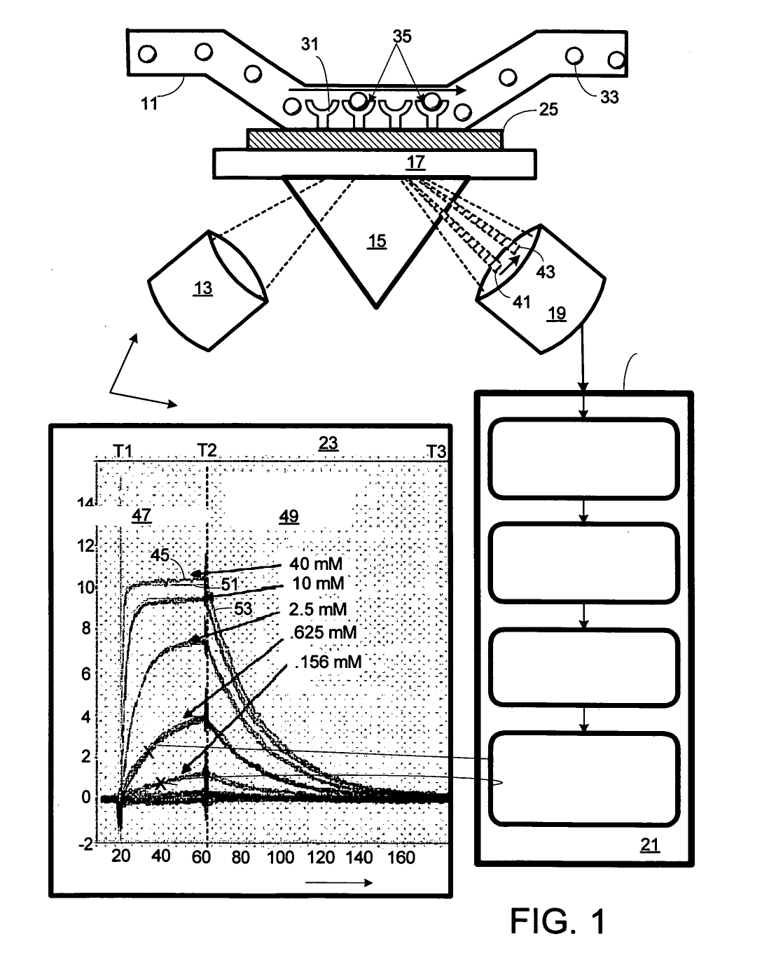

In FIG. 1, the displacement of the resonance angle is schematically shown as a change from a first beam position 41 to a second beam position 43 on photodetector 19. In alternative embodiments, spectral or other forms of SPR sensors are used instead of an angular SPR sensor. Also, the invention provides for different types of optical and other biosensors that can track kinetics. As the binding population changes, so does the resonance angle, which is indicated schematically in FIG. 1 as being input to computer 21 from detector 19.

Computer 21 provides the hardware and software to implement a method ME1, shown flow-charted in FIG. 1. At method segment M1 computer 21 tracks the resonance angle data over time, which in turn represents the extent of binding over time. The end product of one such tracking is represented by a plot 45 of resonance angle versus time, shown on display 23. In this case, the interaction data is tracked over two phases of the tracking duration:

1) an association phase 47 represents binding activity from a time T1 when the fixed interactant is unpopulated to a time T2 when equilibrium (i.e., when the rate of dissociation equals or nearly equals the rate of association) is reached or nearly reached.
2) a dissociation phase 49 during which interactant-free buffer is introduced to the fixed interactant and any bound mobile interactant from time T2 to a time T3 when the amount of binding pairs has reached or nearly reached a minimum (absent some purging activity).

At method segment M2, computer 21 determines a best-fit time-profile curve for the binding interactions. The curve is selected according to a model of the interaction being tracked. In this case, a reversible interaction obeying the laws of mass transport is involved, so exponential curves are fitted: 1) an “association” exponential curve 51 for association phase 47; and 2) a “dissociation” exponential curve 53 for dissociation phase 49. Of course, the best-fit exponential curves largely overlap the plots they are intended to fit, so the curves and plots are most readily distinguished for times when the fit is less optimal.

In general, the type of curve that is fitted is dependent on an interaction model. Models for cooperative binding (which can involve interaction of analytes to form complexes that bind to a target), and for coupled kinetic reactions (in which multiple equilibria are involved in an interaction) yield their own respective curve types.

At method segment M3, computer 21 evaluates the curvature (or non-linearity in time) of the association and dissociation time-profile curves 51 and 53. The curvature of a time-profile curve is taken relative to a linear rate of change. For example, the linear rate of change can be represented by a chord (i.e., a straight-line segment that intersects a curve at both its endpoints) that intersects association curve 47 at times T1 and T2. For every response level between these times, association curve 47 reaches this level before it is reached by the chord. The curvature can be measured as a maximum lead time, an average lead time, or weighted or normalized variations of maximum and average lead time, or other related parameters. In the case of an exponential curve R=e^{-kx}, the exponential constant k can serve as a measure of curvature. In the illustrated case, the exponential constants for time-profile curves are used to evaluate time profile curves 51 and 53 independently. In addition, the product of the exponential constants serves as a combined evaluation parameter for the pair of curves 51 and 53.

At step M4, low curvature profiles are flagged; in other words, computer 21 provides some indication that a curve cannot be relied on to evaluate a parameter of interest with the required precision. For example, in FIG. 1, an “X” through a displayed curve serves as a flag. Alternatively, color, intensity, thickness, and other known highlighting techniques can be used to distinguish sufficient and insufficient curves on a display. Also, text warnings can be used, such as “low on-rate, poor information”.

The evaluations can be separately considered for each parameter of interest. For example, the association phase curvature can be used to determine whether kₐ can be reliably determined, the dissociation phase curvature can be used to determine whether k_{d} can be reliably determined, and some mathematical combination of the curvatures for the two phases can be used to determine whether K_{D} can be reliably determined.

The implications of a low-curvature flag can be that the curve and associated data can vary: 1) the associated data can be discarded and replaced by data from another run, e.g., using a higher concentration of mobile interactant; 2) the data can be supplemented using data from different runs of the same or different concentrations, but the same interactants; or 3) the associated data can be used to evaluate parameters of interest with low precision.

The threshold between insufficient and sufficient curvature can be determined for each parameter of interest empirically for a given sensor system and target during calibration. For example, in FIG. 1, data plots are shown for seven runs at five different concentrations for the same mobile reactant; as might be expected, runs at the same concentration are not well resolved in the graph. For each run, Table I lists: the concentration of the free interactant (e.g., analyte), the exponential constant for the fitted time-profile curve of association (observed on-rate kₒ), the observed and inherently normalized exponential constant for the off-rate (k_{d}), the calculated normalized on-rate (kₐ=(kₒ+k_{d})/[concentration]), and the calculated affinity (K_{D}=k_{d}/kₐ).

TABLE I
Kinetic Parameters of Affinity Determined

| | | |
|---|---|---|
| Given | Fitted Curves | Calculated |

| Concentration | kₒ | k_{d} | kₐ | K_{D} |
|---|---|---|---|---|
| (μM) | (s⁻¹) | (s⁻¹) | (M * s)⁻¹ | nM |
| 0.156 | 0.08736 | 0.03301 | 348,400 | 95 |
| 0.625 | 0.05035 | 0.03636 | 22,376 | 1,600 |
| 2.5 | 0.13782 | 0.03708 | 40,295 | 920 |
| 2.5 | 0.13081 | 0.03413 | 38,672 | 882 |
| 10 | 0.66602 | 0.03286 | 33,742 | 974 |
| 10 | 0.42217 | 0.03359 | 38,858 | 864 |
| 40 | 1.34702 | 0.03302 | 32,850 | 1,010 |

| | | | |
|---|---|---|---|
| All Data | 0.0349 | 36,782 | 949 |

Table I indicates that the calculated values kₐ and K_{D} are relatively close below the double line, but far off the mark for data above the double line. Since the dissociation values k_{d} are reasonably uniform, the fault appears to lie with the exponential constants for the fitted exponential constants of association. Values of kₒ above 0.13 appear to be reliable, while those below may not me. Hence 0.13 can serve as a cut-off curvature value for observed exponential curves of association. Note that further runs at intermediate concentrations (between 2.5 μM and 0.625 μM) might yield lower thresholds, while runs with different interactants can be used to confirm the general applicability of the threshold.

When the curvature is sufficient, as determined at method segment M4, the data from a single run suffices for calculating the parameter or parameters of interest and no further runs are required. This can result in a substantial improvement in throughput versus the typical five runs used to calculate kinetics and affinity values. Coupled with advances in parallelism for SPR sensors that permit a hundred or more runs to be performed using a single SPR machine, the invention provides for a several-hundred fold improvement in throughput relative to non-parallel, multi-run approaches.

This improvement has significant implications for target-based drug discovery and it becomes practical to perform kinetics measurements on more drug candidates. This in turn permits the kinetics measurements to be obtained earlier in the drug discovery process. Since kinetic measurements “include” endpoint measurements, the need for some endpoint tests is obviated. This results in a further increase in throughput for the drug discovery process.

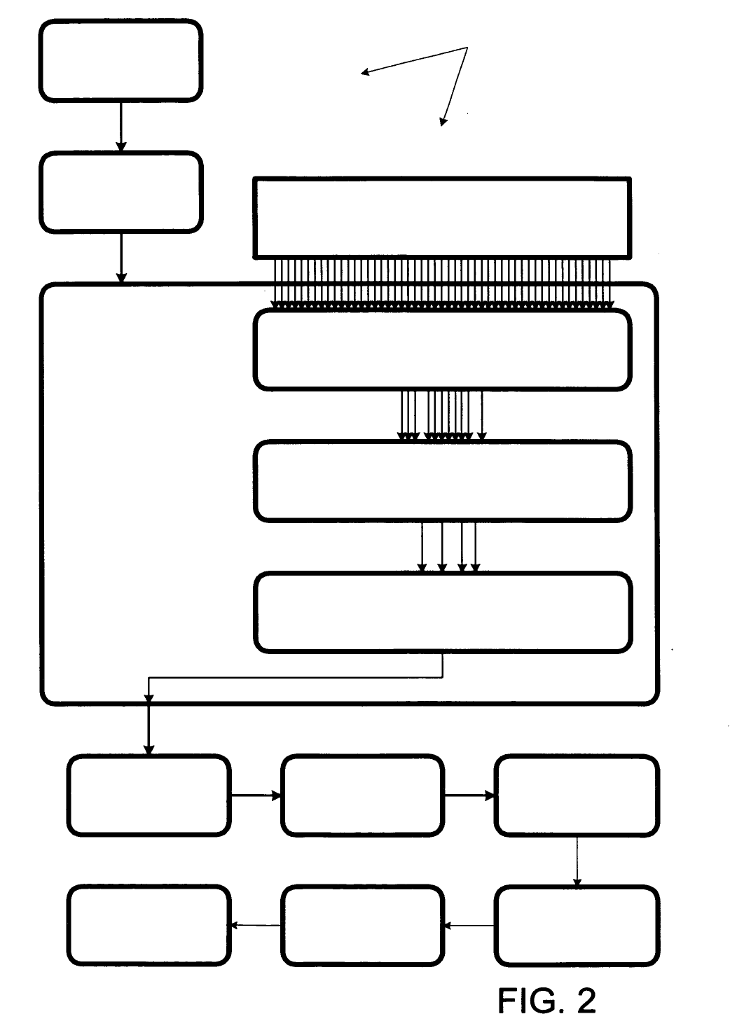

For example, a flow chart of a target-based drug-discovery method ME2 is shown in FIG. 2 comprising: target identification and validation at M21, screen development M22, screening at M23, lead optimization at M24, pre-clinical development at M25, clinical trials at M26, government approval M27, manufacture M28, and disease prevention, relief, and cures at M29. Insofar as described above, this method can be considered typical, although target-based drug discovery methods vary.

However, whereas, screening typically involves secondary screening using endpoint measurements, the present invention provides for kinetic measurements early in secondary screening. Thus, in screening M23, a primary screen is performed at method subsegment M31 using low-precision endpoint measurements on a large (˜10⁶ compounds) drug library 60, yielding a much reduced number (e.g., ˜10³) of hits. At method segment M32 all or most hits are kinetically screened using system AP1 and method ME1, with the target as the fixed interactant and drug candidates as the mobile interactants for respective runs. The kinetics for each target-candidate pair are measured once. The hits yielding insufficient curvature are rejected in the screening process, along with any hits that are reliable determined to have undesirable kinetic and affinity binding values. The resulting leads (e.g., about ˜10²) are then subjected to counter screens at method subsegment M33, either using endpoint or kinetic measurements.

By screening hits immediately for kinetics, those with unfavorable on-rates are excluded from subsequent testing. Complementarily, some hits with moderate affinity but favorable on-rates (that might have been rejected using endpoint testing) can be carried forward. Thus, the process of selecting candidates becomes more robust. Any decrease in throughput due to kinetic versus endpoint testing of the hits is offset by the reduced number of screen stages required and the reduced number of poor candidates that are subjected to repeated testing.

“Monitoring” herein refers to generating an effectively continuous signal or signals representing a succession of states for the subject being monitored. “Effectively continuous” means continuous, as in an analog signal, or involving a sufficient sample rate to adequately capture all state changes of interest for the subject. (For example, in video recorders, a 30 frame-per-second sample rate is effectively continuous.) “Tracking” is “monitoring-plus-recording” the states determined by said monitoring.

“Binding reaction” is a reaction in which plural, typically two, bio-chemical entities become physically coupled. In the context of drug discovery, the binding partners or interactants are typically a drug target and a drug candidate. From the perspective of an SPR sensor, one of the interactants is fixed to a sensor surface, while the other is typically in a solution that is introduced to the fixed partner. In this context, the binding reactions are typically non-covalent and reversible. However, the invention has applicability to irreversible reactions and reactions involving covalent bonds as well.

“Kinetics” refers to reaction rates and how reaction rates change over time. “Kinetic measurement” implies that non-equilibrium conditions are monitored, although equilibrium conditions can also be monitored. Thus, kinetics involves characterizing a profile of binding as a function of time, e.g., as interactants increasing associate or increasing dissociate until equilibrium reached.

A “time-profile” curve is a continuous n-dimensional shape in n+m dimensions, each point of which is a well-defined function of time. In practice, a time-profile curve can be a continuous one-dimensional shape in two Cartesian dimensions, one of which represents time and the other of which represents a mass or other parameter corresponding to the extent of binding between two interactants.

“Fitting” involves selecting from a set of curves the curve that best meets some criterion, such resulting in the lowest sum of least squares of distances of data points from the fitted curve. The set from which the time-profile curve is selected corresponds to a theoretical model for the binding reaction. For example, most reversible binding reactions follow the law of mass transport; in this case, if the concentration of the mobile interactant remains effectively constant, the model calls for an exponential time-profile curve. In this case, the exponential that best fits the data is the time-profile curve for that data.

“Curvature” herein refers to deviations from linearity, e.g., of a time-profile curve. A straight-line (corresponding to a constant binding rate) can be a time-profile curve, but its curvature is zero. For other shapes, curvature values depend on the curvature-related parameter being measured. Where the time profiles are exponential functions of time, the exponential constant can serve as the curvature-related parameter. However, other parameters can include maximal or average time-deflection from a linear reference, area between a linear reference and the time profile, magnitudes of second-derivative peaks (where a rate changes most dramatically), as well as weighted combinations and variations of the foregoing. The linear reference can be a chord connecting two points on the time-profile curve, for example, the points corresponding to 10% and 90% levels in the span of the time-profile curve.

It should be noted that an observed exponential constant of dissociation determined from a fitted time-profile curve should be representative of the dissociation rate constant (k_{d}) for the binding pair. On the other hand, an observed exponential constant of association (kₒ) determined from fitted time-profile curve is not generally representative of the association rate constant (kₐ). Instead, the latter is equal to the former less the dissociation rate constant (k_{d}), with the difference divided by the concentration of the mobile interactant in solution in the vicinity of the fixed interactant, i.e., kₐ=(kₒ−k_{d})/[concentration].

“Validity” herein refers to the confidence level that can be assigned to a fitted time profile as a representative of the binding reaction being studied. When there is more curvature in the kinetic data, the range of viable exponential curve fits is smaller than when there is less curvature. Therefore, there is more range for error when the data is more linear and less basis for confidence in the selected exponential time-profile. “Evaluating the confidence level” here means assigning a value to indicate the confidence level for the fit. The result of the evaluation can be a one-bit value (pass versus fail), or a value on a continuum.

The value resulting from evaluating the confidence level can be a scalar or a vector. For example, one scalar value can be assigned to the association segment of a time profile and another scalar value can be assigned to the dissociation segment. In that case, a decision can be made based on the vector that includes both the association and dissociation scalar values. For example, for the purpose of calculating affinity, the decision to use a time-profile curve can be a function of a product of scalar values for association and dissociation.

What is claimed is:

1. A method comprising:
tracking the kinetics of a binding reaction to yield kinetics data;
fitting a time-profile curve to said kinetics data, said time-profile curve being characterized at least in part by a curvature-related value; and
evaluating the validity of said time-profile curve as a representative of said kinetics at least in part as a function of said curvature-related value.

2. A method as recited in claim 1 wherein said time-profile curve includes an exponential curve having an exponential constant, said curvature-related value being at least in part a function of said exponential constant.

3. A method as recited in claim 2 wherein said parameter related value is said exponential constant.

4. A method as recited in claim 1 wherein said time-profile curve includes an exponential curve of association having an exponential constant of association and an exponential constant of dissociation.

5. A method as recited in claim 4 wherein said parameter-related value is an exponential constant for an observed rate of association.

6. A method as recited in claim 5 wherein said evaluating yields a validity indication.

7. A method as recited in claim 6 further comprising determining an affinity for said binding only if said validity indication indicates that said time-profile curve is a valid representative of said kinetics.

8. A method as recited in claim 1 wherein said binding reaction is between a surface-bound interactant and a mobile interactant that is mobile when not bound to said surface-bound interactant.

9. A method as recited in claim 8 wherein said tracking involves the use of a surface plasmon resonance biosensor.

10. A method as recited in claim 8 wherein said surface bound interactant is a protein.

11. A method as recited in claim 1 wherein said tracking, fitting, and evaluating are performed independently for plural pairs of target-candidate interactants as part of a target-based drug discovery process.

12. A method as recited in claim 11 wherein each of said target-candidate binding pairs includes a respective candidate drug in solution and a common target biomolecule bound to a sensor surface.

13. A method as recited in claim 12 wherein said tracking is preceded by a primary screening of a library of candidate drugs, said screening yielding a number of hits, at least most of said hits being included in respective ones of said pairs of target-candidate interactants.

14. A method as recited in claim 13 wherein method involves testing the drug candidates of some of said drug-candidate binding pairs for interaction with at least one non-target biomolecule after the respective evaluating has been completed.

15. A method as recited in claim 12 wherein method involves testing the drug candidates of some of said drug-candidate binding pairs for interaction with at least one non-target biomolecule after the respective evaluating has been completed.

16. A method as recited in claim 15 wherein a drug candidate is tested for interaction with said non-target biomolecule only if the respective curvature-related value meets a predetermined criterion.

17. A system comprising:
a sensor for monitoring the kinetics of a binding reaction to yield kinetics values; and
a computer including software for gathering said kinetics values to yield a binding-versus-time profile, fitting a time-profile curve to said profile, determining a curvature-related value for said time-profile curve, and evaluating the validity of said time-profile curve as representative of said binding reaction at least in part as a function of said curvature-related value.

18. A system as recited in claim 17 wherein said time-profile curve includes one or more exponential curves and said curvature-related value is a function of one or more exponential constants.

19. A system as recited in claim 17 wherein said curvature related value is an exponential constant for an observed rate of association.

20. A system as recited in claim 17 wherein said sensor is a surface plasmon resonance biosensor.
